(19) United States
(12) Patent Application Publication
(10) Pub. No.: US 2008/0279415 A1
(43) Pub. Date: Nov. 13, 2008

(54) SPEAKER CONE AND DUST CAP ASSEMBLY

(75) Inventors: Daniel Frank Roemer, Oregon, WI (US); Brad Michael Diedrich, Monroe, WI (US); Chad A. Kautz, Winslow, IL (US)

Correspondence Address: KEITH L. JENKINS, 2222 NORTH MCQUEEN ROAD #2069, CHANDLER, AZ, 85225, US

(73) Assignee: MITEK CORP., INC., Monroe, WI (US)

(21) Appl. No.: 11/745,848

(22) Filed: May 8, 2007

(51) Int. Cl. H04R 9/04

(52) U.S. Cl. 381/400

(57) ABSTRACT

A speaker cone and dust cap assembly for a speaker is disclosed having an acoustic web for a dust cap that has a lower surface with a convex shape; a speaker cone with an end web, sized and arranged to close the first end of the former distal the magnet assembly of the speaker, the end web comprising a concave surface shaped conformally with a central portion of the lower surface of the acoustic web; and having the end surface of the end web fixed to the central portion of the lower surface of the acoustic web over substantially the entire surface of the end surface of the end web. The speaker cone may have a cylindrical extension wrapping the first end of the former. The cylindrical extension and the first end of the former may have aligned vents.

### FIELD OF THE INVENTION

The present invention relates to cone and dust cap assemblies for speakers. More particularly, the present invention relates to a cone and dust cap assembly for a woofer.

### BACKGROUND OF THE INVENTION

A conventional loudspeaker, or “speaker”, as used herein, may use a moveable diaphragm, or “speaker cone” to produce sound. Some speaker cones have radially symmetrical curvature, but may have shape variations (some are almost flat) that vary the geometry of the diaphragm from a strict geometric cone. The speaker cone is moved by a former, which also supports the voice coil. The former is attached to the speaker cone. The voice coil, which rests in the magnetic field of a magnet assembly, receives an audio-encoded electrical signal, or “audio signal”, which causes varying current in the voice coil. By interaction of the voice coil current with the magnetic field of the magnet assembly, sound-producing movement of the former and speaker cone results. The voice coil is constrained to one-dimensional motion, perpendicular to the base plane of the speaker cone, by a flexible support structure called a “spider.” The magnet assembly may comprise a magnetically permeable pole piece, a permanent magnet, and a magnetically permeable top plate. The pole piece may feature an annular groove, or “air gap,” to permit motion of the voice coil deeper into the magnetic field of the magnet assembly. The speaker cone is supported at its widest perimeter by a flexible suspension, or “surround”, which, in turn, is supported by a structure called a “basket.” The top plate of the magnet assembly and the spider are also connected to the basket. An opening in the speaker cone at its center is often covered with a dust cap, which reduces the amount of dust that may affect voice coil motion in the annular groove.

Modern automotive audio stereo systems may include woofers weighing in excess of 300 lbs. In order to minimize power consumption, it is desirable to minimize the work done by the speaker.

The inventors have recognized a need for a speaker that minimizes the weight of the speaker cone and dust cap assembly. In order to meet that need, the inventors have developed a novel approach to reducing the weight of the speaker cone and dust cap assembly.

### OBJECTS AND FEATURES OF THE INVENTION

A primary object and feature of the present invention is to provide a more efficient speaker. It is a further object and feature of the present invention to provide such a speaker having a speaker cone with an upper surface conformal to a central portion of the underside of a dust cap. It is a further object of the invention to provide a speaker cone and dust cap assembly that has a reduced weight as compared to conventional speakers. It is yet another object of this invention to provide a speaker cone and dust cap assembly in which the dust cap is the primary acoustic web for producing sound. It is yet another object and feature of the present invention to provide such a speaker in which the speaker cone is fixed to the underside of the dust cap over the entire end surface of the speaker cone. A further primary object and feature of the present invention is to provide such a speaker that is efficient, inexpensive, and handy. Other objects and features of this invention will become apparent with reference to the following descriptions.

### SUMMARY OF THE INVENTION

In accordance with a preferred embodiment hereof, this invention provides a speaker cone and dust cap assembly for a speaker, the speaker having a magnet assembly, a former having first and second ends and vents, such speaker cone and dust cap assembly comprising: at least one acoustic web having at least one lower surface having at least one convex shape; at least one end web sized and arranged to close such first end of such at least one former distal such magnet assembly of such speaker, such end web comprising a concave end surface shaped conformally with at least one central portion of such lower surface of such acoustic web; wherein such end surface of such at least one end web is fixed to such at least one central portion of such at least one lower surface of such at least one acoustic web.

Moreover, it provides such a cone and dust cap assembly further comprising at least one of at least one basket, at least one surround, at least one spider, and at least one voice coil. Additionally, it provides such a cone and dust cap assembly wherein such at least one end web comprises at least one cylindrical extension sized, shaped, and arranged to slidingly engage such former, further comprising at least one vent through such cylindrical extension aligned to at least one such vent in such former.

In accordance with another preferred embodiment hereof, this invention provides a cone and dust cap assembly attachable to the voice coil former of a speaker, comprising: at least one speaker cone having at least one cylindrical portion having an inner diameter, an outer diameter, a first end, and a second end, wherein such at least one cylindrical portion is sized and shaped to assist in attachment of such second end thereof to such former; at least one end web extending across and closing such first end of such at least one cylindrical portion of such at least one speaker cone, wherein such at least one end web has a concave top web surface; at least one dust cap having a concave center portion equal in diameter to such outer diameter of such at least one cylindrical portion of such at least one speaker cone and having at least one lower surface having a conformal shape to such at least one end web; wherein such top surface of such at least one end web is fixed to such portion of such at least one lower surface of such at least one dust cap.

Also, it provides such a cone and dust cap assembly further comprising at least one vent in such at least one cylindrical portion of such at least one speaker cone. In addition, it provides such a cone and dust cap assembly further comprising such voice coil former supporting at least one voice coil. And, it provides such a cone and dust cap assembly further comprising at least one magnet assembly operable to drive such at least one voice coil, at least one spider operable to support such at least one former, at least one basket operable to support such magnet assembly, and at least one surround operable to flexibly couple an outer perimeter of such at least one dust cap to such at least one basket. Further, it provides such a cone and dust cap assembly wherein such at least one top surface of such at least one end web is fixed to such at least one portion of such at least one lower surface of such at least one dust cap using adhesive.

Even further, it provides such a cone and dust cap assembly wherein such adhesive is selected to have a hardness, when cured, that does not exceed the hardness of such at least one dust cap. Moreover, it provides such a cone and dust cap assembly wherein such at least one cylindrical portion is fixed to such former with adhesive. Additionally, it provides such a cone and dust cap assembly wherein such at least one end web has an outer perimeter at such outer diameter of such at least one cylindrical portion and such outer perimeter fixedly abuts such first end of such cylindrical portion to form a shoulder, such shoulder being rounded.

In accordance with another preferred embodiment hereof, this invention provides a cone and dust cap assembly attachable to the former of a voice coil in a speaker comprising: a speaker cone having a concave upper surface and sized, shaped and arranged to be attached as an end piece to such former; a dust cap having a lower surface with a portion conformally shaped to such upper surface of such speaker cone; wherein such top surface of such at least one speaker cone is fixed to a portion of such lower surface of such at least one dust cap.

Also, it provides such a cone and dust cap assembly further comprising such voice coil former having at least one voice coil. In addition, it provides such a cone and dust cap assembly wherein being sized, shaped and arranged to be attached as an end piece to such former comprises having a hollow cylindrical extension adapted to slidingly engage such voice coil former having at least one voice coil. And, it provides such a cone and dust cap assembly wherein such voice coil former having at least one voice coil comprises at least one former vent and such hollow cylindrical extension further comprises at least one speaker cone vent alignable to such at least one former vent. Further, it provides such a cone and dust cap assembly wherein such at least one speaker cone is fixed to a portion of such lower surface of such at least one dust cap using an adhesive.

Even further, it provides such a cone and dust cap assembly wherein such adhesive is selected to have a hardness, when cured, that does not exceed the hardness of such at least one dust cap. Even further, it provides such a cone and dust cap assembly wherein such speaker cone is fixed to such former using adhesive. Even further, it provides such a cone and dust cap assembly wherein such at least one speaker cone comprises a rounded shoulder. Even further, it provides such a cone and dust cap assembly further comprising at least one basket and at least one spider coupled between such former and such at least one basket, wherein such at least one dust cap is flexibly coupled to such basket by a surround.

### BRIEF DESCRIPTION OF THE DRAWINGS

The above and other objects and advantages of the present invention will become more apparent from the following description taken in conjunction with the following drawings in which:

FIG. 1A shows a partially exploded side mid-cross-sectional view illustrating a speaker having the speaker cone and dust cap according to a preferred embodiment of the present invention;

FIG. 1B shows a vertical section view illustrating a speaker cone according to a preferred embodiment of the present invention;

FIG. 2 is a vertical sectional view illustrating the interface between the speaker cone and the dust cap according to a preferred embodiment of the present invention;

FIG. 3 shows a side mid-cross-sectional view illustrating the speaker cone and dust cap of FIG. 1 according to a preferred embodiment of the present invention; and

FIG. 4 shows top plan view illustrating the speaker cone and dust cap assembly of FIG. 1 according to a preferred embodiment of the present invention.

### DETAILED DESCRIPTION OF THE BEST MODES AND PREFERRED EMBODIMENTS OF THE INVENTION

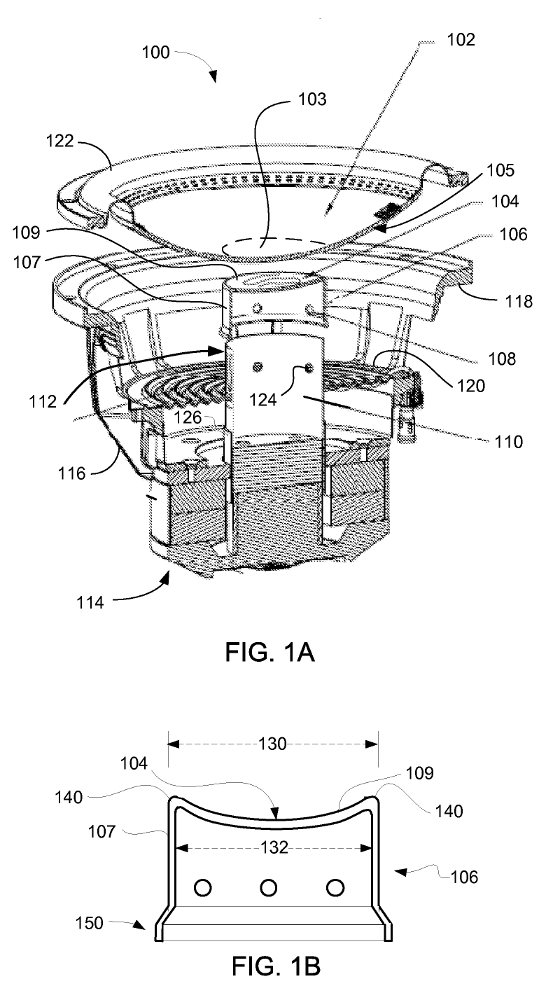

FIG. 1A shows an exploded side mid-cross-sectional view of the speaker 100 illustrating the speaker cone 104 and dust cap 102 according to a preferred embodiment of the present invention. Basket 116 structurally connects magnet assembly 114, spider 120, and rim 118. Spider 120 flexibly supports former 110 having vents 124 that are circumferentially arranged. Vents 125 are illustrated as round holes, but may be of any shape and size consistent with venting back pressure from the motion of the former 110, without compromising the structural strength required for driving the speaker cone 106 (at least embodying herein a speaker cone having a concave upper surface and sized, shaped and arranged to be attached as an end piece to such former) and dust cap 102 (at least embodying herein a dust cap having a lower surface with a portion conformally shaped to such upper surface of such speaker cone). Former 110 supports the voice coil 126 at the second end of the former 110 that is proximal to the magnetic assembly 114. Former 110 is sized, shaped, and arranged to receive speaker cone 106 slidingly over the first, or distal, end 112 of the former 110, and to be fixed into position on the distal end 112 of former 110 (at least embodying herein wherein such speaker cone is fixed to such former using adhesive). For example, the speaker cone 106 may be glued to the distal end 112 of former 110. While the speaker cone 106 is described as glued in the preferred embodiment, those of skill in the art, enlightened by this disclosure, will appreciate the various ways in which speaker cone 106 may be attached to former 110. For example, rather than sliding on the outside of the former 110, speaker cone 106 could be sized, shaped, and arranged to slide into the inside of former 110, or to have a circumferential slot for engaging former 110 on both inner and outer surfaces. For further example, methods other than gluing speaker cone 106 to former 110, such as riveting, welding, etc., may be used.

Speaker cone 106 has a cylindrical portion 107 and an end web 109, as shown. Cylindrical portion 107 is preferably rigid and has circumferentially arranged vents 108 (at least embodying herein at least one vent in such at least one cylindrical portion of such at least one speaker cone), which preferably align with vents 124 in former 110 when speaker cone 110 is fixed to distal end 112 of former 110. The end web 109 (at least embodying herein at least one end web sized and arranged to close such first end of such at least one former distal such magnet assembly of such speaker, such end web comprising a concave end surface shaped conformally with at least one central portion of such lower surface of such acoustic web) is concave on its upper surface 104, which is shaped to be conformal to a central portion 102 of the underside 105 of dust cap 102, as shown (at least embodying herein at least one acoustic web having at least one lower surface having at least one convex shape). Upon reading the teachings of this specification, those with ordinary skill in the art will now understand that, under appropriate circumstances, considering such issues as advances in technology, user preference, material costs, etc., various approaches to affixing a concave end web 109 to a former 110, such as unitary construction or two-piece construction of former-end web sections, etc., may suffice.

Dust cap 102 is a generally concave, as viewed from outside of the speaker 100, and is a preferably rigid acoustic web having a circumferential attachment to flexible surround 122. Dust cap 102 has an undelineated central portion 103 of the same diameter as the outside diameter 130 (see FIG. 1A) of speaker cone 106. The underside 105 of dust cap 102 is convexly shaped, at least in the central portion 103, to conform to the concavity of end web 109 of speaker cone 106, as shown. Preferably, dust cap 102 has a uniform thickness, such that the outer concave shape forms the convex shape of the underside 105. Upon reading the teachings of this specification, those with ordinary skill in the art will now understand that, under appropriate circumstances, considering such issues as desired sound shape, user preference, material costs, etc., various concave shapes of dust cap 102, such as spherical section, sinusoidal section, ellipsoid section, or other curvature, etc., may suffice.

FIG. 1B is a detailed vertical cross-sectional view of speaker cone 106. Cylindrical portion 107 (at least embodying herein wherein such at least one end web comprises at least one cylindrical extension sized, shaped, and arranged to slidingly engage such former, further comprising at least one vent through such cylindrical extension aligned to at least one such vent in such former) has an outside diameter 130 and an inside diameter 132. The inside diameter 132 is preferably slightly larger than the outside diameter of the former 110, so that the speaker cone 106 can slide onto the former 110 (at least embodying herein at least one speaker cone having at least one cylindrical portion having an inner diameter, an outer diameter, a first end, and a second end, wherein such at least one cylindrical portion is sized and shaped to assist in attachment of such second end to such former). The outer surface of the former 110 that engages the speaker cone 106 (at least embodying herein at least one end web extending across and closing such first end of such at least one cylindrical portion of such at least one speaker cone, wherein such at least one end web has a concave top web surface) is preferably coated with adhesive before the speaker cone 106 is engaged thereon, making the engagement permanent when the adhesive cures (at least embodying herein wherein such end surface of such at least one end web is fixed to such at least one central portion of such at least one lower surface of such at least one acoustic web). At the junction of end web 109 and cylindrical portion 107 is circumferential shoulder 140, as shown. Circumferential shoulder 140 (at least embodying herein wherein such at least one speaker cone comprises a rounded shoulder) is preferably rounded, as shown, in order to minimize strain concentration in the dust cap 102 at the circumference of the speaker cone 106. While the dust cap 102 is generally rigid, no material is perfectly so. The flexing of the dust cap 102 at the circumference of the speaker cone 106 may cause strain hardening and cracking of the speaker cone 102 if the strain is overly concentrated by a sharp shoulder. Accordingly, the shoulder 140 is rounded to change the point of application of the strain as the dust cap 102 flexes. Cylindrical portion 107 preferably extends from the distal end of former 110 to the spider 120. The cylindrical portion 107 preferably has a flared end 150 that is sized, shaped, and arranged to be connected to spider 120. The connection of the flared end 150 to spider 120 is preferably by adhesive. Upon reading the teachings of this specification, those with ordinary skill in the art will now understand that, under appropriate circumstances, considering such issues as materials selection, user preference, material costs, etc., various shoulder configurations, such as more or less curved or having a resilient material mounted thereon, etc., may suffice.

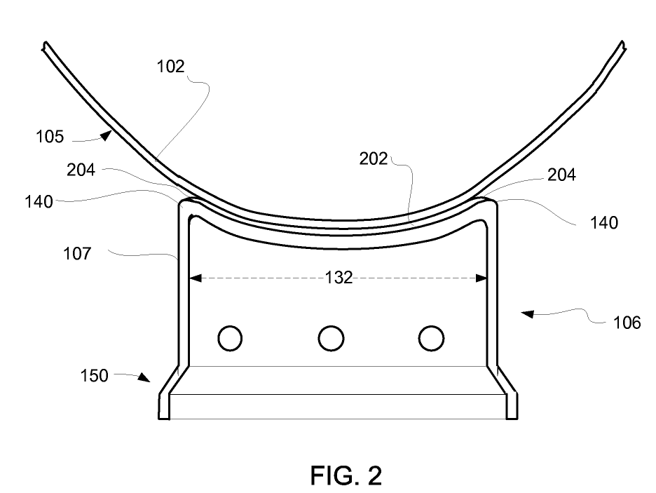

FIG. 2 is a vertical sectional view illustrating the interface between the speaker cone 106 and the dust cap 102 according to a preferred embodiment of the present invention. The speaker cone 106 is preferably attached to the lower surface 105 of dust cap 102 (at least embodying herein at least one dust cap having a concave center portion equal in diameter to such outer diameter of such at least one cylindrical portion of such at least one speaker cone and having at least one lower surface having a conformal shape to such at least one end web) with adhesive 202 (at least embodying herein wherein such top surface of such at least one speaker cone is fixed to a portion of such lower surface of such at least one dust cap), shown in exaggerated scale for purposes of illustration(at least embodying herein wherein such top surface of such at least one end web is fixed to such portion of such at least one lower surface of such at least one dust cap). The layer of adhesive 202 (at least embodying herein wherein such at least one top surface of such at least one end web is fixed to such at least one portion of such at least one lower surface of such at least one dust cap using adhesive) is generally very thin compared to the thickness of end web 109 and of dust cap 102. The adhesive 202 preferably has a bead 204 that merges smoothly into the shoulder 140 to avoid strain concentration. As shown, the adhesive bead 204 may be rounded convexly, relative to the dust cap 102, and merge smoothly into the shoulder 140. In an alternate embodiment, the adhesive bead 204 may be concave relative to dust cap 102, and may merge smoothly into shoulder 140. The adhesive 202 serves to rigidify speaker cone 106 and dust cap 102, forming a laminate that is stronger than a speaker cone 106 and a dust cap 102 that are merely in abutment. As a result of the increased strength, the speaker cone 106 and dust cap 102 can be made of lighter-weight materials, thereby improving the efficiency of the speaker 100. Preferably, the adhesive 202, when cured, has a hardness that is not greater than the hardness of the material of the end web 109 or of dust cap 102 (at least embodying herein wherein such adhesive is selected to have a hardness, when cured, that does not exceed the hardness of such at least one dust cap). Upon reading the teachings of this specification, those with ordinary skill in the art will now understand that, under appropriate circumstances, considering such issues as material properties, available adhesive types, material costs, etc., various approaches to construction, such as producing a former 110 with speaker cone 106 attached and then attaching the dust cap 102 or by first attaching the dust cap 102 to the speaker cone 106 and then attaching the former 110, etc., may suffice.

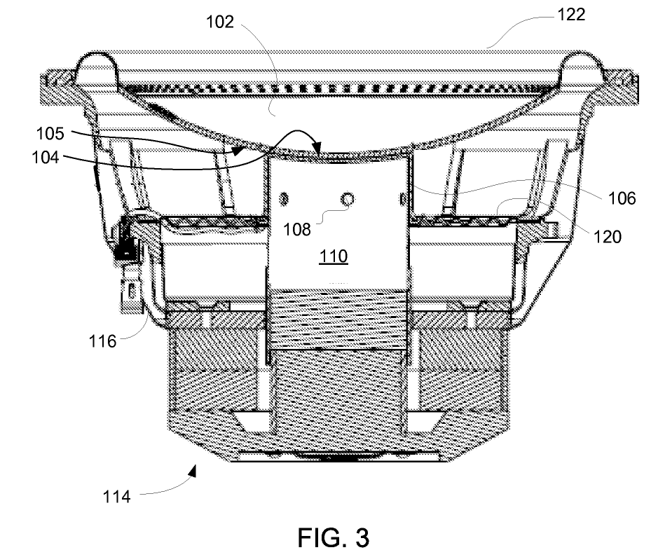

FIG. 3 shows a side mid-cross-sectional view illustrating the speaker 100 with the speaker cone 106 and dust cap 102 of FIG. 1, installed according to a preferred embodiment of the present invention. The lower surface of dust cap 102 is fixed to a conformal upper surface 104 of speaker cone 106, preferably by adhesive 202, as shown. In this configuration, former 110 drives speaker cone 106, which, in turn, drives dust cap 102. The rigidified center section 103 of dust cap 102 is fixed by adhesive to end web 109 of speaker cone 106. Cylindrical section 107 extends to and is fixed by adhesive to spider 120. Vents 108 in the cylindrical portion 107 of the speaker cone 106 align with vents 124 in the former 110 to assist in reducing back pressure within the former 110 (at least embodying herein wherein such voice coil former having at least one voice coil comprises at least one former vent and such hollow cylindrical extension further comprises at least one speaker cone vent alignable to such at least one former vent). While the figures all illustrate an upward orientation of the speaker 100, those of skill in the art will understand that the speaker 100 may be used in various desired orientations, as operational requirements may dictate. Upon reading the teachings of this specification, those with ordinary skill in the art will now understand that, under appropriate circumstances, considering such issues as design goals, desired sound shape, material costs, etc., various former 110, speaker cone 106, and dust cap 102 shapes, such as a former 110 with a cross-sectional shape that is not circular, a speaker cone 106 that adapts a first cross-sectional shape of former 110 to a second cross-sectional shape of dust cap 102, or an area of attachment for speaker cone 106 under dust cap 102 that is off-center, etc., may suffice.

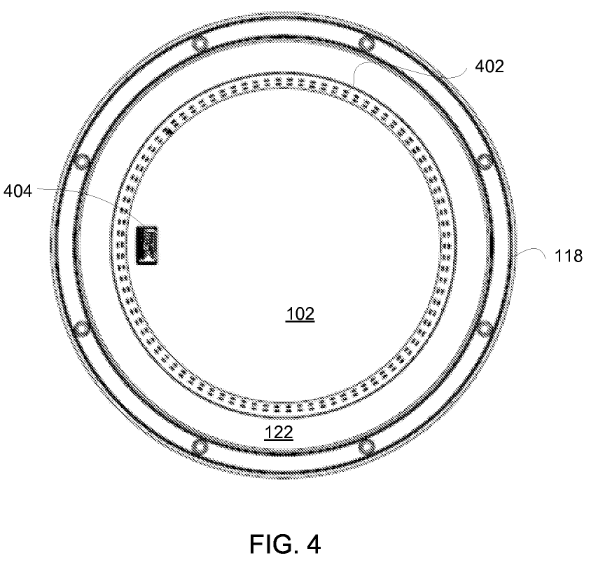

FIG. 4 shows top plan view illustrating the speaker cone and dust cap assembly of FIG. 1 according to a preferred embodiment of the present invention. The dust cap 102 is attached to the flexible surround 122 by means of a flange 402 of the surround 122 that is fixed by adhesive to dust cap 102. The surround 122 is fixed to the rim 118 by fasteners, as is known in the art. Label 404 is preferably embedded in a conformal depression in dust cap 102, and may extend above the top surface of dust cap 102. Preferably, the label 404 is sized, shaped, and arranged to maintain radial symmetry of the mass distribution and stiffness properties of the dust cap 102. Upon reading the teachings of this specification, those with ordinary skill in the art will now understand that, under appropriate circumstances, considering such issues as design goals, desired decibel level, power availability, etc., various configurations for label 404, such as a circumferential label 404, circumferentially arranged labels 404, or no label 404, etc., may suffice.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A speaker cone and dust cap assembly for a speaker, the speaker having a magnet assembly, a former having first and second ends and vents, said speaker cone and dust cap assembly comprising:
at least one acoustic web having at least one lower surface having at least one convex shape;
at least one end web sized and arranged to close such first end of such at least one former distal such magnet assembly of such speaker, said end web comprising a concave end surface shaped conformally with at least one central portion of said lower surface of said acoustic web;
wherein said end surface of said at least one end web is fixed to said at least one central portion of said at least one lower surface of said at least one acoustic web.

2) The cone and dust cap assembly of claim 1, further comprising at least one of at least one basket, at least one surround, at least one spider, and at least one voice coil.

3) The cone and dust cap assembly of claim 1, wherein said at least one end web comprises at least one cylindrical extension sized, shaped, and arranged to slidingly engage such former, further comprising at least one vent through said cylindrical extension aligned to at least one such vent in such former.

4) A cone and dust cap assembly attachable to the voice coil former of a speaker, comprising:
at least one speaker cone having at least one cylindrical portion having an inner diameter, an outer diameter, a first end, and a second end, wherein said at least one cylindrical portion is sized and shaped to assist in attachment of said second end to such former;
at least one end web extending across and closing said first end of said at least one cylindrical portion of said at least one speaker cone, wherein said at least one end web has a concave top web surface;
at least one dust cap having a concave center portion equal in diameter to said outer diameter of said at least one cylindrical portion of said at least one speaker cone and having at least one lower surface having a conformal shape to said at least one end web;
wherein said top surface of said at least one end web is fixed to said portion of said at least one lower surface of said at least one dust cap.

5) The cone and dust cap assembly of claim 4, further comprising at least one vent in said at least one cylindrical portion of said at least one speaker cone.

6) The cone and dust cap assembly of claim 4, further comprising such voice coil former supporting at least one voice coil.

7) The cone and dust cap assembly of claim 6, further comprising at least one magnet assembly operable to drive said at least one voice coil, at least one spider operable to support said at least one former, at least one basket operable to support said magnet assembly, and at least one surround operable to flexibly couple an outer perimeter of said at least one dust cap to said at least one basket.

8) The cone and dust cap assembly of claim 4, wherein said at least one top surface of said at least one end web is fixed to said at least one portion of said at least one lower surface of said at least one dust cap using adhesive.

9) The cone and dust cap assembly of claim 8, wherein said adhesive is selected to have a hardness, when cured, that does not exceed the hardness of said at least one dust cap.

10) The cone and dust cap assembly of claim 4, wherein said at least one cylindrical portion is fixed to such former with adhesive.

11) The cone and dust cap assembly of claim 4, wherein said at least one end web has an outer perimeter at said outer diameter of said at least one cylindrical portion and said outer perimeter fixedly abuts said first end of said cylindrical portion to form at least one shoulder, said at least one shoulder being rounded.

12) A cone and dust cap assembly attachable to the former of a voice coil in a speaker comprising:
a speaker cone having a concave upper surface and sized, shaped and arranged to be attached as an end piece to such former;
a dust cap having a lower surface with a portion conformally shaped to said upper surface of said speaker cone;
wherein said top surface of said at least one speaker cone is fixed to a portion of said lower surface of said at least one dust cap.

13) The cone and dust cap assembly of claim 12, further comprising such voice coil former having at least one voice coil.

14) The cone and dust cap assembly of claim 13, wherein being sized, shaped and arranged to be attached as an end piece to such former comprises having a hollow cylindrical extension adapted to slidingly engage said voice coil former having at least one voice coil.

15) The cone and dust cap assembly of claim 13, wherein said voice coil former having at least one voice coil comprises at least one former vent and said hollow cylindrical extension further comprises at least one speaker cone vent alignable to said at least one former vent.

16) The cone and dust cap assembly of claim 12, wherein said at least one speaker cone is fixed to a portion of said lower surface of said at least one dust cap using an adhesive.

17) The cone and dust cap assembly of claim 16, wherein said adhesive is selected to have a hardness, when cured, that does not exceed the hardness of said at least one dust cap.

18) The cone and dust cap assembly of claim 12, wherein said speaker cone is fixed to such former using adhesive.

19) The cone and dust cap assembly of claim 12, wherein said at least one speaker cone comprises at least one rounded shoulder.

20) The cone and dust cap assembly of claim 12, further comprising at least one basket and at least one spider coupled between such former and said at least one basket, wherein said at least one dust cap is flexibly coupled to said basket by at least one surround.
